(19) United States
(12) Patent Application Publication
(10) Pub. No.: US 2026/0033671 A1
(43) Pub. Date: Feb. 5, 2026

(54) LOCKING MECHANISM FOR A TILT HEAD MIXER

(71) Applicant: Haier US Appliance Solutions, Inc., Wilmington, DE (US)

(72) Inventors: Tomas Garces, Louisville, KY (US); Connor Shea, Louisville, KY (US)

(21) Appl. No.: 18/788,997

(22) Filed: Jul. 30, 2024

(51) Int. Cl. A47J 43/044

(52) U.S. Cl. CPC A47J 43/044; A47J 2043/04481

(57) ABSTRACT

A stand mixer may include a casing having a base and a column extending from the base. The casing may define an interior surface directed toward an interior cavity and an exterior surface directed away from the interior cavity. The stand mixer may include a tilting head that extends transversely between a front end and a rear end. The titling head may be pivotable between a closed position and an opened position. The stand mixer includes a motor positioned in the tilting head and a locking mechanism disposed between the tilting head and the column. The locking mechanism may include a linkage arm extending from a first linkage end to a second linkage end. The locking mechanism may also include a button coupled to the first linkage end and one or more locking hooks coupled to the second linkage end in selective engagement with a catch portion.

### FIELD OF THE DISCLOSURE

The present subject matter relates generally to kitchen appliances, and more particularly to stand mixer appliances.

### BACKGROUND OF THE DISCLOSURE

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. The motor may be provided in a tilting head attached to a base via a stand column. The tilting head may be adjusted to an open position in order to adjust the position of the utensil or in order for a user to more easily access an area in close proximity to the utensil. For convenience, the tilting head may adjust around a pivot point between the stand column and the tilting head. A button may be positioned on top of the tilting head such that the users may unlock a locking mechanism in order to adjust the tilting head.

Many stand mixers implement a locking system for keeping a head of the stand mixer in a closed position, however current embodiments of locking systems present challenges. For instance, the locking system may be adjusted via a button coupled directly to the locking system. Thus, the button must be placed in specific positions in order to physically couple to the locking system. This may decrease functionality in the sense that the button may be positioned in a location that makes it harder for a user to both press the button and lift the tilting head, and in some embodiments the user may be required to use two hands to unlock and open the tilting head. Components positioned within the tilting head may also cause issues and restrict the positioning of the button as well. For instance, the motor is often positioned within the tilting head and takes up a large portion of the space within the tilting head, making it difficult to connect the button and locking system.

As a result, further improvements may be useful, such as to increase functionality of the stand mixer.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a stand mixer is provided. The stand mixer may include a casing, a tilting head, a motor, and a locking mechanism. The casing may comprise a base and a column extending from the base along a vertical direction, the casing defining an interior surface directed toward an interior cavity and an exterior surface directed away from the interior cavity. The tilting head may be positioned on top of the column and may extend transversely between a front end and a rear end of the tilting head. The tilting head may also be pivotable around a pivot point proximate to the rear end. The tilting head may further be pivotable between a closed position and an opened position. The motor may be positioned in the tilting head. The locking mechanism may be disposed between the tilting head and the column. The locking mechanism may include a linkage arm, a button, and one or more locking hooks. The linkage arm may extend from a first linkage end to a second linkage end. The button may be coupled to the first linkage end and disposed proximal to the front end of the tilting head. The one or more locking hooks may be coupled to the second linkage end in selective engagement with a catch portion fixed relative to the column.

In another exemplary aspect of the present disclosure, another stand mixer is provided. The stand mixer may include a casing, a tilting head, a motor, and a locking mechanism. The casing may comprise a base and a column extending from the base along a vertical direction, the casing defining an interior surface directed toward an interior cavity and an exterior surface directed away from the interior cavity. The tilting head may be positioned on top of the column and may extend transversely between a front end and a rear end of the tilting head. The tilting head may also be pivotable around a pivot point proximate to the rear end. The tilting head may further be pivotable between a closed position and an opened position. The motor may be positioned in the tilting head. The locking mechanism may be disposed between the tilting head and the column. The locking mechanism may include a linkage arm, a button, and one or more locking hooks. The linkage arm may extend from a first linkage end to a second linkage end. The button may be coupled to the first linkage end and disposed proximal to the front end of the tilting head. A force on the button may transfer to a button arm coupled to the first linkage end causing the linkage arm to reposition. The one or more locking hooks may be coupled to the second linkage end in selective engagement with a catch portion fixed relative to the column. The one or more locking hooks may contact the catch portion fixed relative to the column in a closed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to exemplary embodiments of the present disclosure.

FIG. 2 provides a perspective view of the exemplary stand mixer of FIG. 1 with a column cover removed.

FIG. 3A provides a perspective view of a portion of a locking mechanism of a stand mixer according to exemplary embodiments of the present disclosure, wherein the locking mechanism is in a locked position.

FIG. 3B provides a perspective view of a portion of the locking mechanism of a stand mixer according to exemplary embodiments of the present disclosure, wherein the locking mechanism is in an unlocked position.

FIG. 4A provides an overhead perspective view of a portion of the exemplary locking mechanism of FIG. 3A, according to exemplary embodiments of the present disclosure.

FIG. 4B provides an overhead perspective view of a portion of the exemplary locking mechanism of FIG. 3B, according to exemplary embodiments of the present disclosure.

FIG. 5 provides an overhead perspective view of a portion of the exemplary locking mechanism of FIGS. 3A and 3B, wherein the locking mechanism is in a position between the locked position and the unlocked position.

FIG. 6 provides a perspective view of a tilting head transition of the exemplary stand mixer of FIG. 1, wherein the tilting head transitions to an opened position.

FIG. 7 provides a perspective view of a front end of a tilting head of the exemplary stand mixer of FIG. 1, according to exemplary embodiments of the present disclosure.

FIG. 8A provides an overhead perspective view of a portion of the exemplary locking mechanism of FIGS. 3A and 3B, wherein a portion of a tilting head cover is present.

FIG. 8B provides a rear perspective view of a portion of the exemplary locking mechanism of FIGS. 3A and 3B, wherein a portion of a tilting head cover is present.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The phrase “in one embodiment,” does not necessarily refer to the same embodiment, although it may. The terms “first,” “second,” and “third” may be used interchangeably to distinguish one component from another and are not intended to signify location or importance of the individual components.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

Due to current embodiments of locking mechanisms in stand mixers, there is little variation in the available positioning of a button used to unlock a tilting head, such that the button is often positioned proximate of a rear end of the tilting head. This positioning may be due to the button being coupled (e.g., directly or through other components of the locking mechanism) to one or more locking hooks used to hold the tilting head in a closed position. Thus, the coupling of the button to the one or more locking hooks may interfere with other components also positioned within the tilting head (e.g., a motor) in existing mixers.

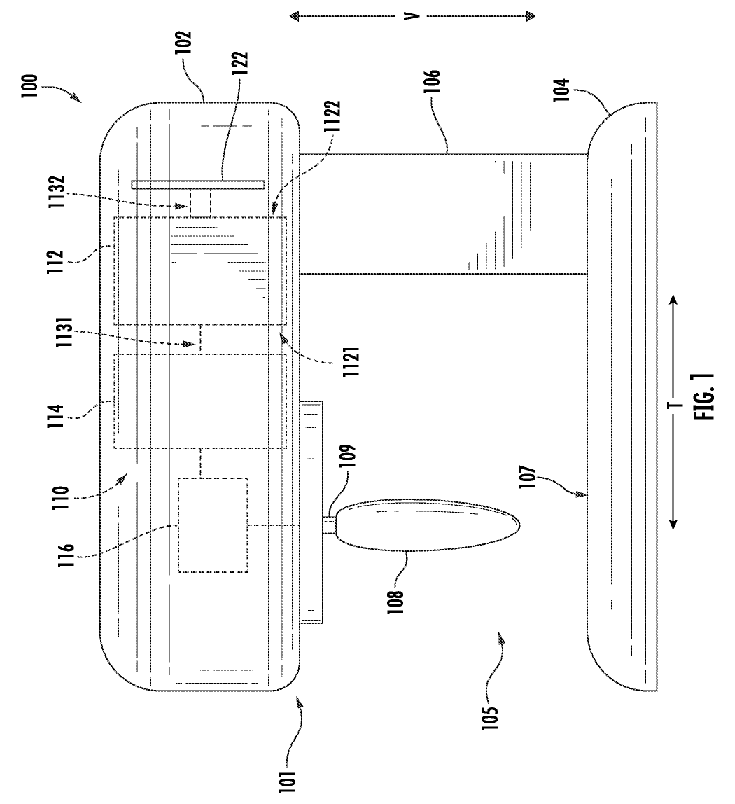

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a planetary or reduction gearbox 114, and a (e.g., bevel) gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

As will be described in later detail below, motor housing 102 may be pivotable (e.g., tilted) to a plurality of positions around a pivot point. The pivot point may be a connection between a rear end of motor housing 102 and column 106, such that motor housing 102 and column 106 are coupled together. Motor housing 102 may be pivotable to a closed position. Motor housing 102 may also be pivotable to an opened position.

A drivetrain 110 may be provided within motor housing 102 and is configured for coupling motor 112 to a shaft 109 (e.g., a mixer shaft), such that shaft 109 is rotatable via motor 112 through drivetrain 110. Drivetrain 110 may include planetary gearbox 114, bevel gearbox 116, etc. An opening 132 for a horizontal accessory shaft 130 may align with the rotational axis of motor 112. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102. The rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

Stand mixer 100 may include a controller 122 provided within casing 101. For example, controller 122 may be located within motor housing 102 of casing 101. Controller 122 may be a microcontroller, as would be understood, including one or more processing devices, memory devices, or controllers. Controller 122 may include a plurality of electrical components configured to permit operation of stand mixer 100 and various components therein (e.g., motor 112). For instance, controller 122 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 122 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 122 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

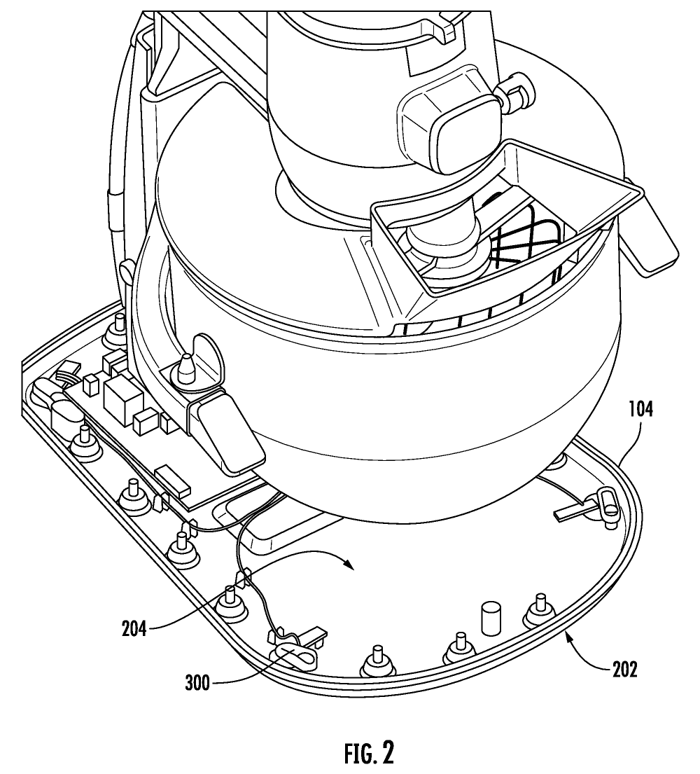

FIG. 2 provides an interior view of base 104 of stand mixer 100. In FIG. 2, a cover (e.g., covering base 104, column 106, or each of base 104 and column 106) is removed for the sake of clarity. Casing 101 may define an interior cavity 206. For instance, interior cavity 206 may be formed within each of base 104, column 106, and motor housing 102. A plurality of components (e.g., electrical components, mechanical components, control components, etc.) may be provided within interior cavity 206. For instance, casing 101 may define an exterior surface 202 and an interior surface 204. Interior surface 204 may be directed toward interior cavity 206 of casing 101 while exterior surface 202 is directed away from the interior cavity 206. One or more components may be selectively fixed or attached to interior surface 204 (e.g., of base 104 or column 106).

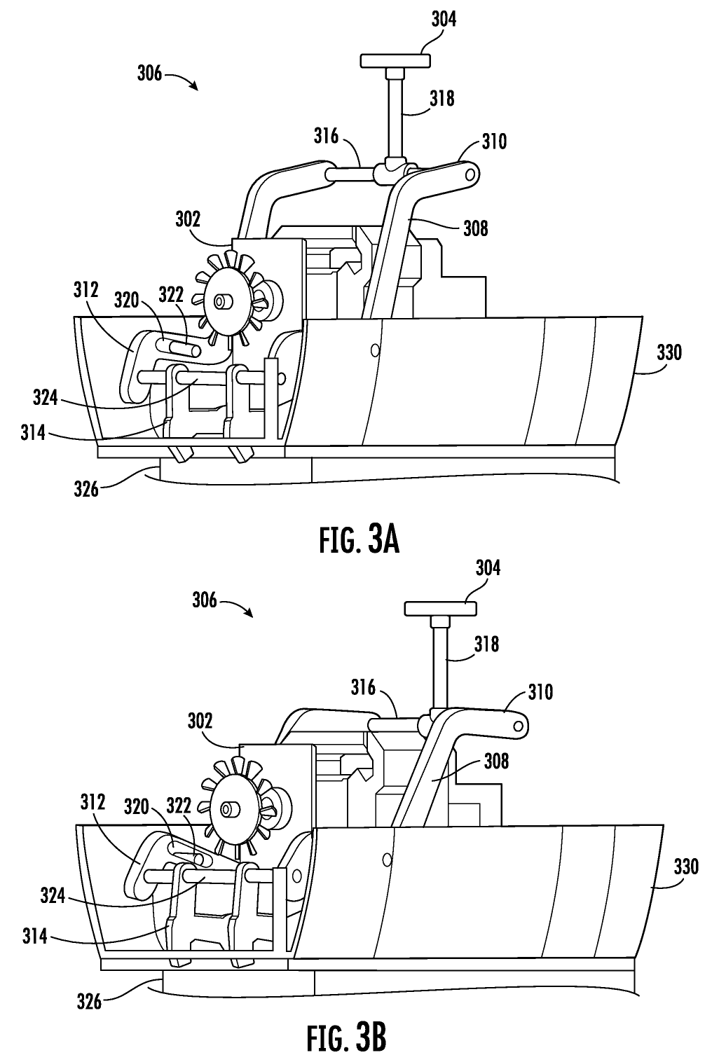

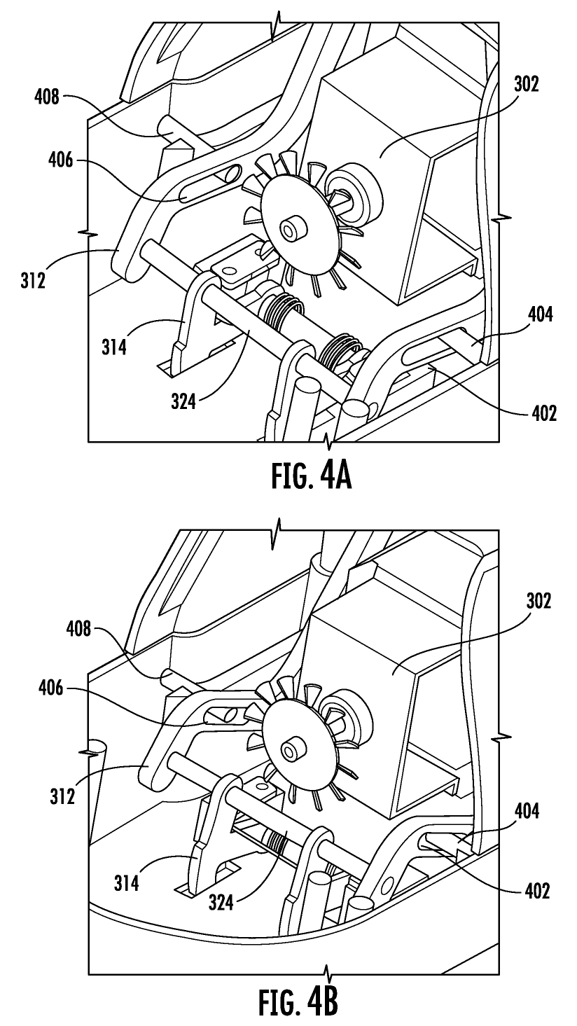

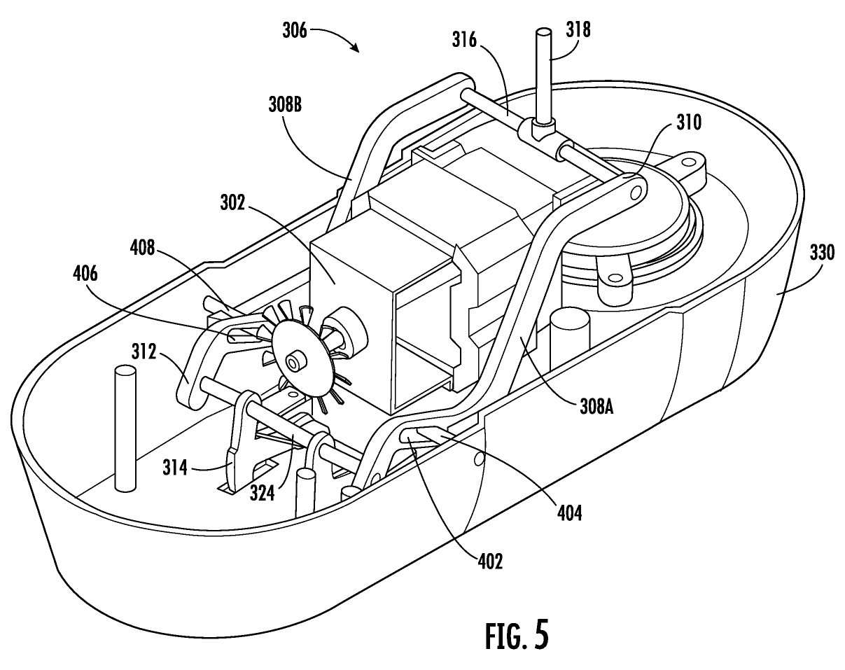

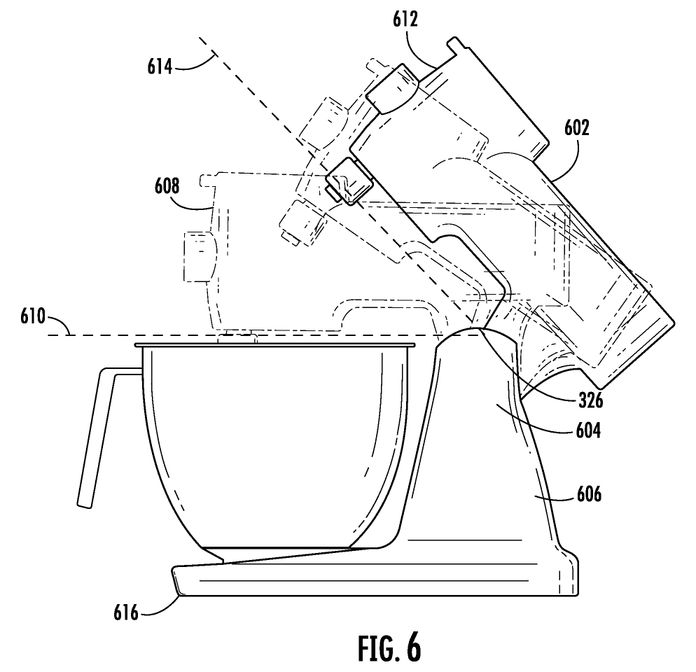

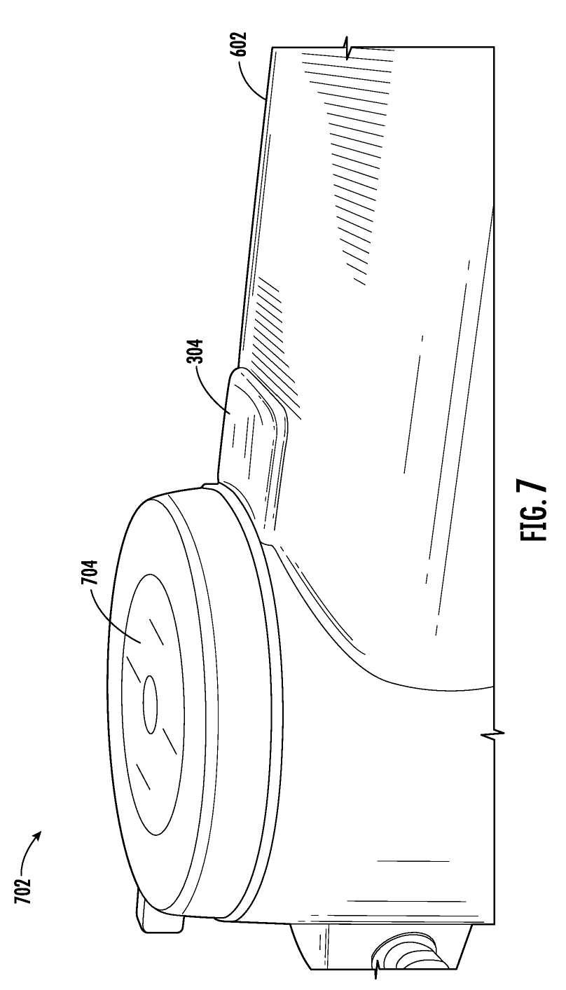

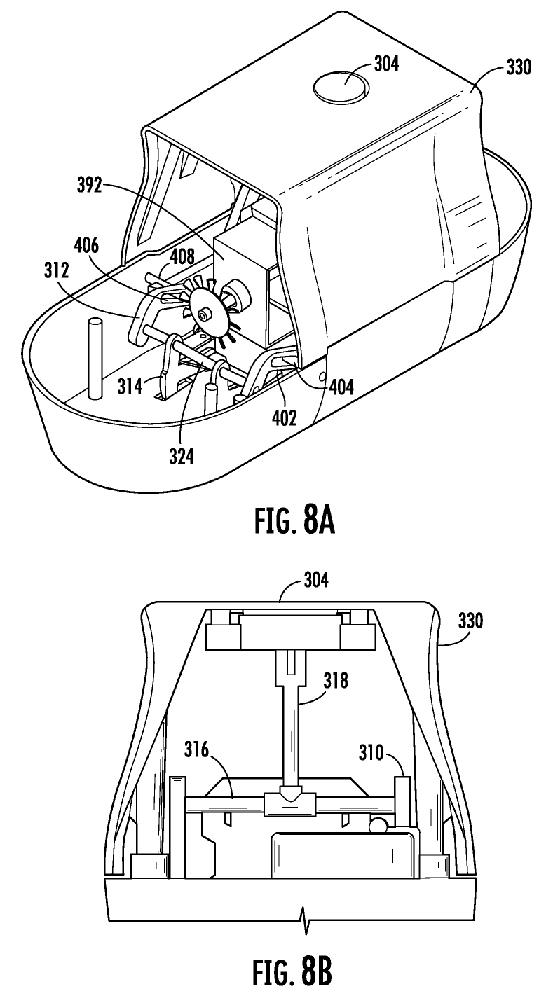

Turning now generally to FIGS. 3 through 8, FIG. 3A provides a perspective view of a portion of a locking mechanism (e.g., of a stand mixer 100—FIGS. 1 and 2) according to exemplary embodiments of the present disclosure, wherein the locking mechanism is in a locked position. FIG. 3B provides a perspective view of a portion of the locking mechanism of a stand mixer according to exemplary embodiments of the present disclosure, wherein the locking mechanism is in an unlocked position. FIG. 4A provides an overhead perspective view of a portion of the exemplary locking mechanism of FIG. 3A, according to exemplary embodiments of the present disclosure. FIG. 4B provides an overhead perspective view of a portion of the exemplary locking mechanism of FIG. 3B, according to exemplary embodiments of the present disclosure. FIG. 5 provides an overhead perspective view of a portion of the exemplary locking mechanism of FIGS. 3A and 3B, wherein the locking mechanism is in a position between the locked position and the unlocked position. FIG. 6 provides a perspective view of a tilting head transition of the exemplary stand mixer of FIG. 1, wherein the tilting head transitions to an opened position. FIG. 7 provides a perspective view of a front end of a tilting head of the exemplary stand mixer of FIG. 1, according to exemplary embodiments of the present disclosure. FIG. 8A provides an overhead perspective view of a portion of the exemplary locking mechanism of FIGS. 3A and 3B, wherein a portion of a tilting head cover is present. FIG. 8B provides a rear perspective view of a portion of the exemplary locking mechanism of FIGS. 3A and 3B, wherein a portion of a tilting head cover is present.

A tilting head 602 (e.g., including or provided as motor housing 102—FIGS. 1 and 2) may be pivotable (e.g., tilted) to a plurality of positions around a pivot point 604. The pivot point 604 may be located between a rear end of tilting head 602 and a portion of column 606 (e.g., relative to the transverse direction T). Thus, the pivot point 604 may be a location that tilting head 602 and column 606 (e.g., including or provided as column 106—FIGS. 1 and 2) come into direct contact. In another embodiment, the pivot point 604 may be located on an additional intermediate element (not pictured) that is coupled to tilting head 602 and column 606 separately such that the element connects tilting head 602 and column 606. Tilting head 602 may first be positioned in a closed position 608. As will be described in greater detail below, the closed position 608 may be associated with a locked tilting head, wherein a locked tilting head is positioned along or proximate a horizontal plane 610 (e.g., along a horizontal direction, such as transverse direction T). Tilting head 602 may also be pivotable from the closed position 608 to an opened position 612. The opened position 612 may be associated with a preset angle 614, wherein the preset angle 614 describes the opened position 612 with respect to horizontal plane 610 (e.g., along a horizontal direction, such as transverse direction T). The opened position 612 may be associated with an unlocked tilting head.

Tilting head 602 may include a user interface panel 702 (e.g., as will be described in detail below). The user interface panel 702 may be disposed proximal to a front end of the tilting head 602. The term proximal, as used herein, may refer to a position associated with a certain portion of the tilting head 602 (e.g., a certain half, a certain quarter, etc.) relative to a set direction (e.g., the transverse direction T) when the tilting head 602 is in the closed position 608. Thus, the user interface panel 702 located proximate to the front end of the tilting head 602 may refer to the user interface panel 702 being positioned on a front half of the tilting head 602. The front end of the tilting head 602 may be positioned over a base 616 of the stand mixer. The base 616 of the stand mixer may be associated with an area used to position items for mixing (e.g., a bowl). The front half of the tilting head 602 may also be associated with a utensil attached to the tilting head 602. The user interface panel 702 may include one or more interface elements 704 (e.g., buttons, switches, sliders, capacitive touch panels, etc.). The one or more elements 704 may each be associated with a different function of the stand mixer (e.g., an interaction with the element may send a signal to a controller, wherein the signal includes instructions pertaining to a certain component of the stand mixer). For example, a first set of user interface panel elements 704 may be associated with a function of a motor 302 (e.g., turning on the motor 302, speeding the motor 302 up, slowing the motor 302 down, turning the motor 302 off, etc.). As another example, a second set of user interface panel elements 704 may be associated with a positioning of the utensil attached to the tilting head 602 (e.g., repositioning the utensil by moving it left, right, forward, back, up, down, etc.). As yet another example, a third user interface panel element 704 may be associated with prohibiting and supplying power to the stand mixer as a whole (e.g., an on/off element).

As shown, a button 304 may be included with or provided (e.g., mounted) on tilting head 602. The button 304 may be disposed proximal to the front end of the tilting head 602. Thus, the user interface panel 702 may be located on the same end of the tilting head 602 as the button 304. A pivot point 604 may be located proximal to a rear end of the tilting head 602. Thus, the pivot point 604 located proximal to the rear end of the tilting head 602 may refer to the pivot point 604 being positioned on a rear half of the tilting head 602. The rear end of the tilting head 602 may be positioned over a column 606 of the stand mixer such that the pivot point 604 couples the rear end of the tilting head 602 to the column 606. Notably, the pivot point 604 may be located on an opposite end of the tilting head 602 as compared to the button 304 and user interface panel 702 (e.g., the button 304 and user interface panel 702 located on the front half of the tilting head 602 and the pivot point 604 located on the rear half of the tilting head 602). Thus, the user may be able to press the button 304 and adjust the tilting head 602 (e.g., pivot the tilting head 602 around the pivot point 604) using one hand in order to increase user satisfaction and efficiency of the stand mixer.

The button 304 may be positioned on the tilting head 602 such that a user may easily access the button 304 (e.g., from a front portion of the tilting head 602). For instance, the button 304 may be positioned on a front end of the tilting head 602, wherein the front end of the tilting head 602 is not associated with a pivot point 604 of the tilting head 602. In one embodiment, the button 304 is fitted into a cut out portion of a casing 330 of the tilting head 602, such that the button 304 is flush with the casing 330 of the tilting head 602. In another embodiment, the button 304 is placed on top of the casing 330 of the tilting head 602 and extends through the casing 330 of the tilting head 602, such that the button 304 is raised in comparison to the casing 330 of the tilting head 602.

The stand mixer may include a locking mechanism 306 positioned within the tilting head 602 and extending to the column 606. The locking mechanism 306 may lock the tilting head 602 against the column 606 such that the tilting head 602 stays in a closed position 608. The locking mechanism 306 may also unlock the tilting head 602 from the column 606 such that the tilting head 602 may be freely pivotable around the pivot point 604. The locking mechanism 306 may include a linkage arm 308. The linkage arm 308 may extend from a first linkage end 310 to a second linkage end 312. The locking mechanism 306 may also include the button 304. The button 304 may be coupled to the first linkage end 310. The locking mechanism 306 may further include one or more locking hooks 314. The one or more locking hooks 314 may be coupled to the second linkage end 312.

In one embodiment, the button 304 may be a physical button such that the physical button has a freedom of movement in a vertical direction V. Thus, a force applied to the button 304 may cause the button 304 to descend from a starting position (e.g., a user pressing the button down). Once the force is removed from the button 304, the button 304 may ascend back to the starting position (e.g., through the use of a spring). The locking mechanism 306 may further comprise a first rod 316. The first rod 316 may extend between the button 304 and the first linkage end 310 to permit a force on the button 304 to be transferred to the linkage arm 308 through the first rod 316. The button 304 may also couple to the first rod 316 via a button arm 318. The button 304 may be coupled to the button arm 318, such that the button arm 318 extends from the bottom of the button 304. The button arm 318 may be pivotable relative to the linkage arm 308 (e.g., where the button arm 318 is coupled to the first rod 316). In another embodiment, the button 304 may be a second user interface panel or an element of the user interface panel 702, such that button 304 registers an input and sends a signal to a controller.

As previously discussed, the linkage arm 308 may extend from the first linkage end 310 to the second linkage end 312, such that the linkage arm 308 couples the button 304 to the one or more locking hooks 314. The linkage arm 308 may include a straight arm segment. The linkage arm 308 may also embody one or more different structures (e.g., an “S” shape) in order to efficiently couple the button 304 to the locking hooks 314. Notably, the linkage arm 308 may extend around a motor 302 (e.g., motor 112—FIG. 1) positioned within the tilting head 602 from the first linkage end 310 to the second linkage end 312.

The linkage arm 308 may further define a horizontal pivot axis between the first linkage end 310 and the second linkage end 312. The linkage arm 308 may also include a guide track 320. The guide track 320 may be positioned proximal to the second linkage end 312 of the linkage arm 308. The guide track 320 may receive a stabilizing rod 322, wherein the stabilizing rod 322 is firmly coupled to a casing 330 of the tilting head 602, such that the stabilizing rod 322 may guide the movement of the linkage arm 308. The guide track 320 may be defined along a portion of the linkage arm 308. The guide track 320 may include or be provided as a cut out portion of the linkage arm 308 in the shape of a cylinder, wherein the cut out portion is approximately the same width as the diameter of the stabilizing rod 322. The cut out portion may also be considered a cavity in the linkage arm 308. Thus, the first linkage end 310 of the linkage arm 308 descending may cause the second linkage end 312 of the linkage arm 308 to ascend. Likewise, the second linkage end 312 descending may cause the first linkage end 310 to ascend. The linkage arm 308 may be movable between two positions. A first position (e.g., FIG. 3A) may be associated with a locked position, wherein the button 304 is in an unpressed position. A second position (e.g., FIG. 3B) may be associated with an unlocked position, wherein the button 304 is in a pressed position. The linkage arm 308 may reposition from the first position to the second position and momentarily be in a position between the first position and the second position. As the linkage arm 308 repositions from the first position to the second position, this reposition may cause the linkage arm 308 to rotationally pivot around the horizontal pivot axis (e.g., the first linkage end 310 descends, and the second linkage end 312 ascends) and the reposition may also cause the linkage arm 308 to translationally shift towards the front end of the tilting head 602.

The linkage arm 308 may include or be provided as two separate arm segments 308A, 308B (e.g., first and second arm segments respectively—FIG. 5). Each arm segment 308A, 308B may have a first linkage end 310 and a second linkage end 312. As shown, the first rod 316 may extend laterally between the first linkage ends of the two arm segments 308A, 308B at the first linkage end 310 and a second rod 324 may extend laterally between the second linkage ends of the two arm segments 308A, 308B at the second linkage end 312. Thus, the two arm segments 308A, 308B are coupled together and may move in unison. The two arm segments 308A, 308B may be disposed on opposite lateral sides of the motor 302. By disposing one arm segment on each lateral side of the motor 302, the motor 302 will not interfere with a motion path of the arm segments 308A, 308B. Each arm segment 308A, 308B may include a guide track 320, such that a first arm segment guide track 402 on the first arm segment 308A receives a first stabilizing rod 404 and a second arm segment guide track 406 on the second arm segment 308B receives a second stabilizing rod 408.

The one or more locking hooks 314 may be coupled to the second linkage end 312 in selective engagement with a catch portion 326 fixed relative to the column 606. The catch portion 326 may be provided as a portion of the column 606 that extends outwards, such that the portion restricts movement of the one or more locking hooks 314 in an upwards direction (e.g., such as vertical direction V). The catch portion 326 may also be provided as a cavity in the column 606 that receives the one or more locking hooks 314 and also restricts movement of the one or more locking hooks 314 in the upwards direction. The one or more locking hooks 314 may also be coupled to a second rod 324 extending laterally between the second linkage end 312 of the two arm segments 308A, 308B comprising the linkage arm 308. The one or more locking hooks 314 may be movable between two positions. A first locking hook position (e.g., FIG. 4A) may be associated with a closed position. In the closed position, the tilting head 602 may be in a locked position and the one or more locking hooks 314 may extend through a bottom of the tilting head 602. Further, the one or more locking hooks 314 may contact the catch portion 326 defined on the column 606 while in the closed position.

A second locking hook position (e.g., FIG. 4B) may be associated with an unlocked position, wherein the one or more locking hooks 314 are disengaged from the catch portion 326 defined on the column 606. The one or more locking hooks 314 may disengage with the catch portion 326 by slightly translating toward the front of the tilting head 602 and lifting (e.g., due to the pivot of the linkage arm 308). The locking hooks 314 may reposition from the first locking hook position to the second locking hook position and momentarily be in a position between the first locking hook position and the second locking hook position. The reposition of the locking hooks 314 from the first locking hook position to the second locking hook position may cause the locking hooks 314 to lift vertically up, such that in the second locking hook position, the locking hooks 314 are at a vertically greater height than at the first locking hook position. The locking hooks 314 may lift up to a point that the locking hooks 314 do not extend through the bottom of the tilting head 602 while in the second locking hook position.

Upon disengaging the one or more locking hooks 314 that may hold the tilting head 602 in the closed position 608 with the column 606, the tilting head 602 may be pivotable from the closed position 608. In one embodiment, the tilting head 02 may be pivotable to an opened position 612. Upon reaching the opened position 612, the tilting head 602 may be held in place at the opened position 612. In the process of tilting from the closed position 608 to the opened position 612, the tilting head 602 may be at least momentarily positioned at any angle between the closed position 608 and the opened position 612. The tilting head 602 may be held in place at the opened position 612 via a component in contact with the column 606. The tilting head 602 may also be held in place at the opened position 612 due to the opened position 612 being a point of equilibrium in which the tilting head 602 is able to balance, such that there is an even amount of weight on either side of the pivot point 604.

Furthermore, FIGS. 3 through 8 may function as follows. A force applied to the button 304 (e.g., a user pressing the button 304) may transfer to the first rod 316 via the coupling of the button 304 to the first rod 316 (e.g., the button arm 318). The force may then transfer to the two arm segments 308A, 308B of the linkage arm 308 via the coupling of the first linkage end 310 of each arm segment 308A, 308B coupled to the first rod 316. The first linkage end 310 of each arm segment 308A, 308B may then be forced to reposition, therefore causing the linkage arm 308 to reposition. The reposition of the linkage arm 308 may be guided by the guide track 320 and stabilizing rods 322 such that the linkage arm 308 is only capable of repositioning along the path of the guide track 320. The guide track 320 may notably aid in redirecting the force applied to the button 304 to the linkage arm 308 such that the reposition causes the one or more locking hooks 314 to disengage from the catch portion 326 of the column 606. Furthermore, once the force applied to the button 304 is removed, the guide track 320 ensures that the locking mechanism 306 returns to the original position and the locking hooks 314 re-engage with the catch portion 326 (e.g., the position of FIG. 3A) such that the process may be repeated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer comprising:
a casing comprising a base and a column extending from the base along a vertical direction, the casing defining an interior surface directed toward an interior cavity and an exterior surface directed away from the interior cavity; a tilting head positioned on top of the column, the tilting head extending transversely between a front end and a rear end of the tilting head and pivotable, around a pivot point proximate to the rear end, between a closed position and an opened position; a motor positioned in the tilting head; and a locking mechanism disposed between the tilting head and the column, wherein the locking mechanism comprises:
a linkage arm extending from a first linkage end to a second linkage end, a button coupled to the first linkage end and disposed proximal to the front end of the tilting head, and one or more locking hooks coupled to the second linkage end in selective engagement with a catch portion fixed relative to the column.

2. The stand mixer of claim 1, wherein the one or more locking hooks contact the catch portion defined on the column in a closed position.

3. The stand mixer of claim 1, wherein the locking mechanism further comprises a button arm extending between the button and the first linkage end to permit a force on the button to be transferred to the linkage arm through the button arm.

4. The stand mixer of claim 3, wherein the button arm is pivotally coupled to the first linkage end.

5. The stand mixer of claim 3, wherein the locking mechanism defines a horizontal pivot axis between the first linkage end and the second linkage end, the second linkage end being pivotable about the horizontal pivot axis to permit disengagement from the catch portion in response to the transferred force on the button.

6. The stand mixer of claim 1, further comprising a guide track defined along a portion of the linkage arm.

7. The stand mixer of claim 1, wherein the linkage arm extends around the motor from the first linkage end to the second linkage end.

8. The stand mixer of claim 1, wherein the linkage arm comprises two arm segments disposed on opposite lateral sides of the motor.

9. The stand mixer of claim 8, wherein a first rod extends laterally between the two arm segments at the first linkage end and a second rod extends laterally between two arm segments at the second linkage end.

10. The stand mixer of claim 9, wherein the one or more locking hooks are fixed to the second rod extending laterally between the second linkage end of the two arm segments.

11. A stand mixer comprising:
a casing comprising a base and a column extending from the base along a vertical direction, the casing defining an interior surface directed toward an interior cavity and an exterior surface directed away from the interior cavity; a tilting head positioned on top of the column, the tilting head extending transversely between a front end and a rear end of the tilting head and pivotable, around a pivot point proximate to the rear end, between a closed position and an opened position; a motor positioned in the tilting head; and a locking mechanism disposed between the tilting head and the column, wherein the locking mechanism comprises:
a linkage arm extending from a first linkage end to a second linkage end, a button coupled to the first linkage end and disposed proximal to the front end of the tilting head, wherein a force on the button transfers to a button arm coupled to the first linkage end causing the linkage arm to reposition, and
one or more locking hooks coupled to the second linkage end in selective engagement with a catch portion fixed relative to the column, wherein the one or more locking hooks contact the catch portion fixed relative to the column in a closed position.

12. The stand mixer of claim 11, wherein the button arm is pivotally coupled to the first linkage end.

13. The stand mixer of claim 11, wherein the locking mechanism defines a horizontal pivot axis between the first linkage end and the second linkage end, the second linkage end being pivotable about the horizontal pivot axis to permit disengagement from the catch portion in response to the transferred force on the button.

14. The stand mixer of claim 11, further comprising a guide track defined along a portion of the linkage arm.

15. The stand mixer of claim 11, wherein the linkage arm extends around the motor from the first linkage end to the second linkage end.

16. The stand mixer of claim 11, wherein the linkage arm comprises two arm segments disposed on opposite lateral sides of the motor.

17. The stand mixer of claim 16, wherein a first rod extends laterally between the two arm segments at the first linkage end and a second rod extends laterally between two arm segments at the second linkage end.

18. The stand mixer of claim 17, wherein the one or more locking hooks are coupled to the second rod extending laterally between the second linkage end of the two arm segments.
